(19) United States
(12) Patent Application Publication
(10) Pub. No.: US 2005/0132622 A1
(43) Pub. Date: Jun. 23, 2005

(54) Public transportion advertising device

(76) Inventor: Scott Robert Strong, Oakville (CA)

Correspondence Address: STIKEMAN ELLIOTT, 1600-50 O'CONNOR STREET, OTTAWA, ON, KIP LS2, CA

(21) Appl. No.: 11/013,334

(22) Filed: Dec. 17, 2004

Related U.S. Application Data
(60) Provisional application No. 60/530,659, filed on Dec. 19, 2003.

(51) Int. Cl. G09F 3/00

(52) U.S. Cl. 40/318

(57) ABSTRACT

Many public transportation vehicles such as buses, subway trains, etc. are equipped with overhead, horizontal bars carrying passenger assist straps or hand holds. An advertising device for use in association with such straps includes a panel for receiving advertisements and a connector such as a bracket assembly, a C-clip or a strap for connecting the panel to a horizontal bar or a passenger assist strap.

### BACKGROUND OF THE INVENTION

1. Field of the Invention

This application claims priority from U.S. Provisional Patent application Ser. No. 60/530,659 filed Dec. 19, 2003.

This invention relates to an advertising device for use on public transportation vehicles.

2. Discussion of the Prior Art

It is common practice to place advertisements in public transportation vehicles such as buses, subway trains, commuter trains, etc. This type of advertising is effective, because a large number of people use public transportation on a daily basis and thus are repeatedly exposed to the same advertising message. Moreover, passengers on public transportation vehicles constitute a captive audience. The advertisements in question are usually in the form of posters attached to various surfaces of vehicles. Obviously, there are limits to the amount of space on a vehicle for advertisements. Thus, a need exists for another form of advertisements for use on a public transportation vehicle.

An object of the present invention is to meet the above identified need by providing an advertising device which is relatively simple and compact, and readily visible to passengers in a public transportation vehicle.

Another object of the invention is to provide an advertising device which is relatively inexpensive, and which can be easily installed in public transportation vehicles.

### GENERAL DESCRIPTION OF THE INVENTION

Accordingly, the invention relates to an advertising device for use on public transportation vehicles containing an overhead, horizontal bar and passenger assist straps having a top loop for attaching the strap to a bar, and a bottom loop for grasping by a passenger, said device comprising:
a panel having a front surface for receiving an advertisement, and a rear surface; and
a connector for connecting said panel to one of a passenger assist strap and a horizontal bar carrying the strap.

Many public transportation vehicles such as buses, subway trains, etc. are equipped with passenger assist straps, which are also referred to as hand holds (see U.S. Pat. Nos. 2,974,611 and 3,521,571). Such passenger assist straps present an area in a vehicle which has not been used for advertising purposes. A passenger must look up at a strap before grasping the strap. Accordingly, a strap with advertising associated therewith is a good medium for public transportation advertising.

### BRIEF DESCRIPTION OF THE DRAWINGS

The invention is described below in greater detail with reference to the accompanying drawings, wherein:

FIG. 1 is an exploded, isometric view of a first embodiment of an advertising device in accordance with the invention;

FIG. 2 is a side view of the device of FIG. 1 in the installed position;

FIG. 3 is a side view of a second embodiment of the device of the present invention;

FIG. 4 is an exploded, side view of a third embodiment of the device of the present invention;

FIG. 5 is an exploded, partly sectioned, side view of a fourth embodiment of the device of the present invention;

FIG. 6 is a side view of a fifth embodiment of the device of the present invention;

FIG. 7 is an exploded isometric view of a sixth embodiment of the device of the present invention; and

FIGS. 8 and 9 are exploded, partly sectioned, side views of seventh and eighth embodiments of the device of the present invention

### DESCRIPTION OF PREFERRED EMBODIMENT

In the following, the same reference numerals have been used to identify the same or similar elements in the various figures of the drawings.

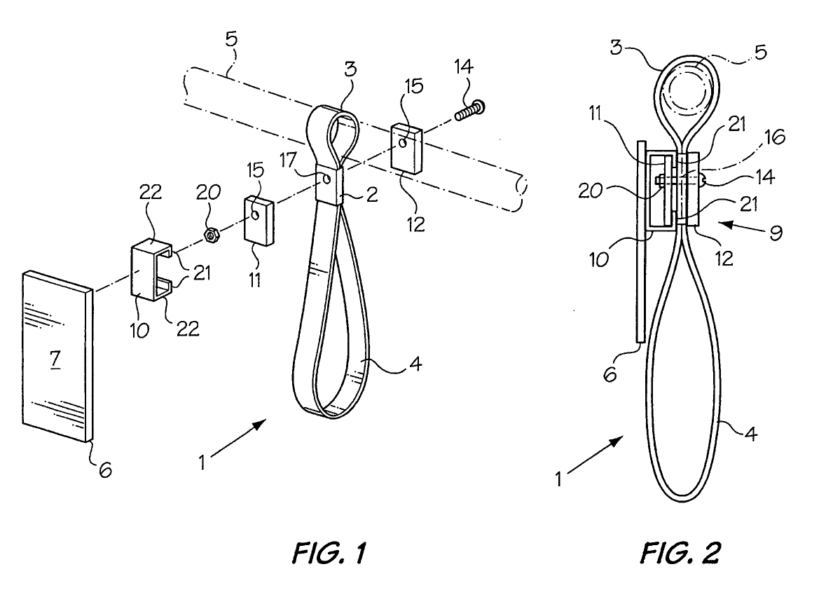

Referring to FIG. 1, a conventional passenger assist strap indicated generally at 1 includes a neck 2 separating the strap into a top loop 3 and a bottom loop 4. The top loop 3 is used to mount the strap 1 on an overhead, horizontal bar 5 of the type which normally runs the length of one or both sides of a public transportation vehicle. The bottom loop 4 is grasped by a standing passenger in the vehicle to assist in maintaining balance while the vehicle is in motion.

The first embodiment of the device of the present invention includes a panel 6 having a front surface 7 for receiving an advertisement and a rear surface (not shown). The panel 6 can be rigid or flexible, and can be formed of a variety of materials such as a metal, e.g. aluminum, a plastic such as acrylic, polyvinyl chloride or polyethylene, neoprene or cardboard. The panel 6 can take any shape such as rectangular (as shown), circular or oval. Moreover, the front surface of the panel can have a relief, i.e. be three-dimensional. An advertising message is printed or otherwise applied to the front surface 7 of the panel 6. For example, an advertisement can be printed on paper with an adhesive backing for removable attachment to the panel 6. It is also possible merely to leave a first advertisement on the panel 6 and glue successive, new advertisements over the first advertisement.

The panel 6 is mounted on the passenger assist strap 1 using a connector in the form of a bracket assembly indicated generally at 9 (FIG. 2). The bracket assembly 9 includes a generally C-shaped bracket 10, which is glued or otherwise attached to the rear surface of the panel 6. The bracket 10 can be integral with the panel 6. A pair of small plates 11 and 12 are used to clamp the panel 6 and the bracket 10 to the neck 2 of the strap 1. One plate 11 is slid into the bracket 10, and the bracket is placed against the front of the strap neck 2. The plate 12 is placed against the rear of the neck 2, a bolt 14 is in the strap 1 and the neck 2, respectively into the bracket 10. A nut 20 in the bracket 10 receives the bolt 14 for securing the elements of the bracket assembly 9 together. As shown in FIG. 2, when the bolt 14 is screwed into the nut 20, the opposed, outer free ends 21 of the arms 22 of the bracket 10 are sandwiched between the plate 11 and the neck 2.

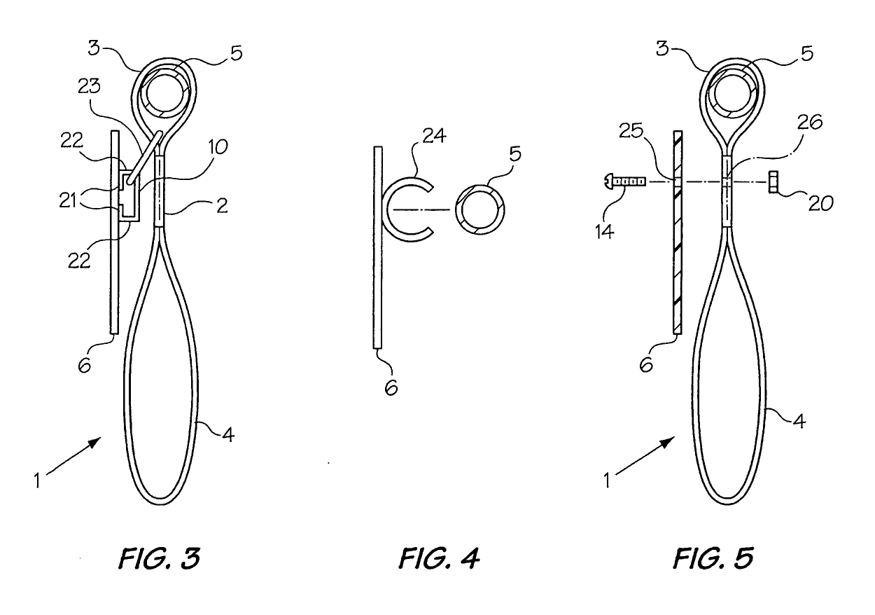

In the second embodiment of the invention shown in FIG. 3, the outer free ends 21 of the arms 22 of the bracket 10 are glued or otherwise attached to the rear surface of the panel 6, and a loop 23 is passed through the top loop 3 of the passenger assist strap 1 and the bracket 10 to secure the panel 6 to the strap.

The third embodiment of the invention which is shown in FIG. 4 includes a resilient C-clip 24 attached to the rear surface of the panel 6. It is merely necessary to snap the clip 25 onto the rail 5 to connect the panel thereto.

A bolt 14 and a nut 20 are used to fasten the panel 6 of the neck 2 and the strap 1 in the fourth embodiment of the invention (FIG. 5). The bolt 14 extends through aligned holes 25 and 26 in the panel 6 and in the neck 2, respectively.

The fifth embodiment of the invention illustrated in FIG. 6 is similar to the second embodiment of the invention, except that a smaller, resilient loop 27 is used to attach the bracket 10 and consequently the panel 6 to the neck 2 on the strap 1.

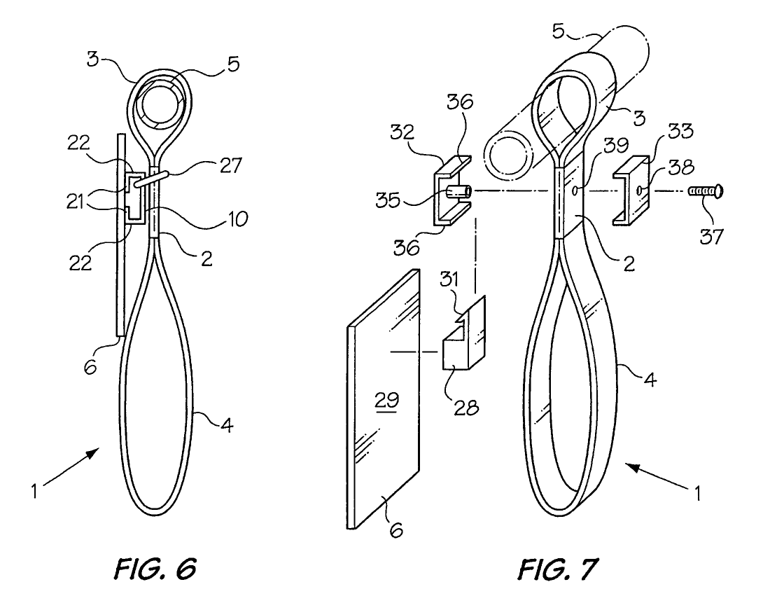

With reference to FIG. 7, the sixth embodiment of the invention includes a block 28 connected to the rear surface 29 of the panel 6 with a resilient J-clip 31 extending upwardly (or downwardly—not shown) from the top, rear edge thereof. A bracket defined by C-shaped front and rear plates 32 and 33, respectively holds the clip 31 and consequently the panel 6 on the sleeve 2. An internal threaded sleeve or nut 35 extends rearwardly from the center of the front plate 32 a distance greater than the length of the arms 36 of the plate. A bolt 37 extends through aligned holes 38 and 39 in the plate 33 and the strap 1, respectively into the nut 35 to fasten the plates together on the strap. Because the arms 36 of the plate 32 are shorter than the nut 35, when the device is assembled, there is a gap between the free ends of the arms 36 of the plate 32 and the neck 2. The resilient free end of the clip 31 is pushed upwardly or downwardly through the bottom or top gap to connect the block 28 and the panel 6 to the strap 1.

Alternatively, both arms 36 of the front plate 32 are the same length as the nut 35. When assembling the device, the free end of the J-clip is placed between the neck 2 and the front plate 32 above the bottom arm or below the top arm 36. The bolt 37 is tightened so that one arm 36 retains the clip 31 against the neck 2, securing the block 28 and the panel 6 to the strap.

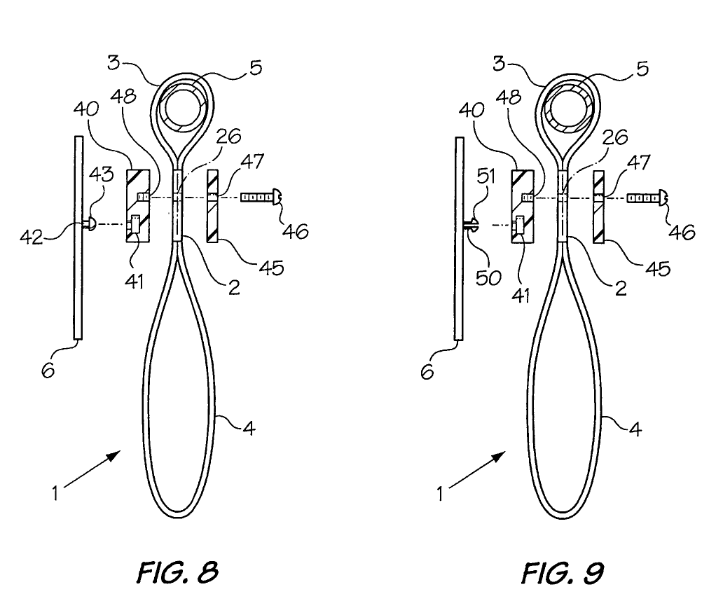

The seventh embodiment of the invention, which is shown in FIG. 8 includes a plastic block 40 containing a recess 41 for receiving a pin 42 extending outwardly from the rear surface of the panel 6. The recess 41 is T-shaped in cross section so that, once inserted, the large head 43 of the pin 42 is retained in the recess. In order to be able to insert the pin 42 into the recess 41, the periphery of the entrance to the recess is flexible. A plate 45 is mounted on the rear side of the neck 2. A bolt 46 extends through aligned holes 47 and 26 in the plate 45 and the strap 1, respectively into a threaded recess 48 in the block 40 to securely fasten the block and consequently the panel 6 to the strap 1. The recess 48 in the block 40 can contain an internally threaded, reinforcing sleeve (not shown).

The eighth embodiment of the invention shown in FIG. 9 is identical to that illustrated in FIG. 8, except that the pin 42 is replaced by a split pin 50, i.e. a pin which is split longitudinally, and the periphery of the entrance into the recess 41 in the block 40 is stiff. When inserting the pin 50 into the recess 41, the arms of the pin 50 flex together and, when the pin is fully inserted in the recess the arms spring apart so that the larger head 52 of the pin retains the pin in the recess.

1. An advertising device for use on public transportation vehicles containing an overhead, horizontal bar and passenger assist straps having a top loop for attaching the strap to a bar, and a bottom loop for grasping by a passenger, said device comprising:
a panel having a front surface for receiving an advertisement, and a rear surface; and
a connector for connecting said panel to one of a passenger assist strap and a horizontal bar carrying the strap.

2. The advertising device of claim 1, wherein said connector includes a C-shaped bracket attached to the rear surface of said panel, L-shaped arms on said bracket extending outwardly from said rear surface; a first plate retained by said arms of the bracket for abutting a front surface of an assist strap, a second plate for abutting a rear surface of an assist strap; said first and second plates having holes for receiving a bolt to fasten the plates and consequently the bracket and panel to the assist straps.

3. The advertising device of claim 1, wherein said connector includes a C-shaped bracket having L-shaped arms for attachment to the rear surface of the panel; and an endless loop extending through an assist strap top loop and said bracket, whereby the panel is suspended from said top loop of the assist strap.

4. The advertising device of claim 1, wherein said connector includes a C-clip attached to the rear surface of said panel for clipping onto an overhead, horizontal bar in a vehicle.

5. The advertising device of claim 1, wherein said connector includes a bolt for extending through said panel and an assist strap; and a nut for receiving the bolt.

6. The advertising device of claim 1, wherein said connector includes a C-shaped bracket having L-shaped arms for attaching the bracket to the rear surface of the panel; and an endless resilient loop for extending around and releasably grasping an assist strap.

7. The advertising device of claim 1, wherein said connector includes a block attached to the rear surface of the panel; an inverted, resilient J-clip extending upwardly or downwardly from said block and spaced apart from said panel; a C-shaped bracket for connection to a front surface of a passenger assist strap, said bracket having a top arm, a bottom arm and a central cylindrical nut for receiving a bolt extending through the strap from a rear surface thereof, at least one of the top and bottom arms being shorter than said nut, whereby, when the bracket is connected to a strap, there is a space between one of the top and bottom arms of the bracket and the strap for receiving the J-clip.

8. The advertising device of claim 1, wherein said connector includes a block attached to the rear surface of the panel; an inverted, resilient J-clip extending upwardly or downwardly from said block and spaced apart from said panel; a C-shaped bracket for connection to a front surface of a passenger assist strap, said bracket having a top arm, a bottom arm and a central cylindrical nut for receiving a bolt extending through the strap from a rear surface thereof, whereby the J-clip can be inserted between the top arm or the bottom arm and the assist strap to connect the block and the panel to the strap.

9. The advertising device of claim 1, wherein said connector includes a pin extending outwardly from the rear surface of the panel said pin having a head thereon; a block having a recess with a T-shaped cross section for receiving a retaining the head of the pin, and a threaded bore in said block for receiving a bolt extending through an assist strap from the rear thereof.

10. The advertising device of claim 9, wherein said recess in said block includes an entrance having a flexible periphery for admitting the head of the pin.

11. The advertising device of claim 9, wherein said pin is split longitudinally for flexing during entry into said recess in the block.
